(19) United States
(12) Patent Application Publication
(10) Pub. No.: US 2013/0339842 A1
(43) Pub. Date: Dec. 19, 2013

(54) BROWSER-ENGINE MODE SWITCHING METHOD AND BROWSER

(71) Applicants: Yong Zhang, Beijing (CN); Tianping Wang, Beijing (CN); Liang Tian, Beijing (CN)

(72) Inventors: Yong Zhang, Beijing (CN); Tianping Wang, Beijing (CN); Liang Tian, Beijing (CN)

(73) Assignee: BEINING QIHOO TECHNOLOGY COMPANY LIMITED, BEIJING (CN)

(21) Appl. No.: 14/002,032

(22) PCT Filed: Feb. 2, 2012
(86) PCT No.: PCT/CN12/70842

§ 371 Date: Aug. 28, 2013

(30) Foreign Application Priority Data
Feb. 28, 2011 (CN) 201110047803.9

(51) Int. Cl. G06F 17/22

(52) U.S. Cl. CPC G06F 17/2247
USPC 715/234

(57) ABSTRACT

The present invention discloses a browser-engine mode switching method and a browser, wherein said method comprises: building a feature library which includes a corresponding relation between each type of web page internal information and the matching engine mode; when the browser has opened a web page in the current engine mode, collecting at least one type of web page internal information of said web page and switching to the matching engine mode with reference to the feature library. The present invention can effectively detect on which kind of core the current web page is based so as to switch the browser to the corresponding engine mode.

### FIELD OF THE INVENTION

The present invention relates to the field of Internet, in particular to a browser-engine mode switching method and a browser.

### BACKGROUND OF THE INVENTION

The core of a browser can be called core or layout engine or page rendering engine. It is responsible for acquiring contents (HTML, XML, images, etc.) of web pages, sorting out information (e.g. adding CSS, etc.) and calculating web page displaying modes, and outputting them as web pages that can be seen by users. Different browser cores have different interpretations to the web page writing syntax, so the same web page may have different rendering effects in browsers of different cores, and this is why web page creators need to test the web page display effect in browsers of different cores.

Current browser cores mainly include Trident core, i.e. IE core, which is for use by IE browser; Gecko core, which is mainly for use by Firefox browser; WebKit core, which is for use by Safari browser, Google Chrome browser, Sogou browser; and Presto core, which is mainly used in Opera mini browser for cell phone platforms. The following descriptions are made by taking WebKit and Trident as examples.

WebKit is core of open source browser, which has an efficient and stable engine and a clear source code structure, and which has a fast rendering speed and is easy to maintain; the most significant advantage thereof is the extremely fast speed. Trident is core of IE browser, which is called IE core for short hereinafter. Web sites usually use this engine to carry web page contents, so it won the widest support in this aspect; and the most significant advantage thereof is the good compatibility.

The browsers with IE core have a very large market share, so web pages provided at present by most web sites in the market are designed on the basis of IE core, some contents of these web pages can only be normally run on the browser with IE core, and the browser that is run using WebKit core cannot normally display contents of these web pages. For example, some controls running on these web pages can be called and started only by the browser with IE core, but they cannot be opened on the browser that runs on the basis of WebKit core; codes for building page structures of web pages are written with some special program languages, and these codes can be normally opened only by the browser with IE core, if they are opened by a browser that runs on the basis of WebKit core, a page structure disorder or word display disorder will occur.

However, when using the IE core to access a complicated web page, problems of slow speed, non-smooth and collapsing will easily occur, while the WebKit is more adapted to complicated web pages. But considering that the IE core still has a dominating position in the market, it cannot be directly abandoned, so some web sites specially design web pages of two versions, i.e. the WebKit version and the IE version, web pages of one version are for displaying by a browser based on the WebKit core, while web pages of the other version are for displaying by a browser based on the IE core. Owing to the speed advantage of the WebKit core, a better user experience can be brought to the user when using the browser of WebKit core, so the web sites usually provide default web pages that are based on the WebKit core in preference.

In addition, contents provided by some web sites in the market at present have certain requirements on the browser speed, so they are especially suitable for the browser based on the WebKit core, therefore, these web sites design the web pages specially based on the WebKit core, and some contents of the web pages can be normally run only by the browser based on the WebKit core, and the browser that is run using the Trident core cannot normally display these web page contents.

With respect to the above-mentioned situations, a dual-engine mode browser with both WebKit core and IE core appeared in the market, so that the WebKit core having the “fastest speed” or the IE core having the “best compatibility” is automatically selected according to the compatibility condition of web pages. As for how the web page compatibility condition is learned, this dual-engine browser mainly identifies the website (e.g. www.360.cn) of the web page that is attempted to be accessed by the user at present, and then identifies in a list whether the WebKit core or the IE core is suitable for said address, and then starts the core suitable for this address; if the list does not include any record of this web page, the automatic switching cannot be performed and a manual switching by the user is necessary.

But the user might not know the original function of this web page, so he cannot determine whether a problem occurs. For example, this web page is displayed as a disordered page structure in the present engine mode, but the user may believe that this is what the web page should look like, and he cannot determine whether any problem occurs, so it is even harder for him to determine that the non-matching engine mode of the browser causes the problem.

Even if the user discovers the problem, he would not know how to solve it, for example, this web page has a video control, which cannot be played and displays an error in the current engine mode, but the user does not know that it is caused by the engine mode, he would probably think that it is a problem of the web page itself, and would not know that the problem can be solved by switching the engine mode of the browser, or the user do not know how to switch because the entrance to switching of the browser engine mode is not obvious.

Meanwhile, if the list does not include record of this web page and thus automatic switching cannot be performed, the dual-engine browser needs to upload this website to the server side, so that it is verified officially and manually whether the website has a problem in the current engine mode, if yes, this web page will be added into the list according to its matching engine mode and the server side will distribute list upgrade to browsers on each of the terminals.

The way of identifying through the website entered by the user before opening the web page by the browser is too unitary and less reliable, because the websites cannot be listed exhaustively, and many web pages will be newly added every day, and the update of web page list will always be later than the generation of new websites, besides, the list needs to be maintained manually, which is inefficient and costly.

### SUMMARY OF THE INVENTION

In view of this, the technical problem to be solved by the present invention is to provide a browser-engine mode switching method and a browser, which can effective detect on which kind of core the current web page is based so as to switch the browser to the corresponding engine mode.

To solve the above-mentioned technical problem, the present invention discloses a browser-engine mode switching method, which comprises: building a feature library which includes a corresponding relation between each type of web page internal information and the matching engine mode; when the browser has opened a web page in the current engine mode, collecting at least one type of web page internal information of said web page and switching to the matching engine mode with reference to the feature library.

Moreover, said method further comprises: said feature library further including a corresponding relation between each type of website property and the matching engine mode; and when the browser has opened a web page in the current engine mode, collecting at least one type of website property of said web page and switching to the matching engine mode with reference to the feature library.

Moreover, said method further comprises: said feature library further including a corresponding relation between the address format and the matching engine mode; and collecting, by the browser, addresses of the servers where the web pages are located, and switching to the matching engine mode with reference to the feature library.

Further, said feature library further including a time duration threshold; when the browser opens a web page in the current engine mode, detecting, by the browser, the time duration for opening the web page, and determining, with reference to the feature library, if said time duration exceeds the time duration threshold, switching to the matching engine mode, otherwise, remaining at the current engine mode.

Further, the step of switching to the matching engine mode with reference to the feature library including: setting priorities for said engine modes, collecting various web page internal information and/or website property and/or address of the server and/or opening time duration of the web page, and performing a hit in said feature library, identifying an engine mode with the highest priority among the engine modes respectively corresponding to the hit web page internal information and/or website property and/or address of the server and/or opening time duration, and making the browser to operate in said engine mode.

Further, the step of switching to the matching engine mode with reference to the feature library including: setting priorities for said various web page internal information and/or website property and/or address of the server and/or opening time duration, collecting one by one the web page internal information or website property and/or address of the server and/or opening time duration of said web page according to the order of priorities, and performing a hit in said feature library, if hit and an engine mode different from the current engine mode is matched, stopping the collection and switching to said engine mode.

Further, the step of switching to the matching engine mode with reference to the feature library including: setting weights for said various web page internal information and/or website property and/or address of the server and/or opening time duration, collecting various web page internal information and/or website property and/or address of the server and/or opening time duration of said web page, and performing a hit in said feature library, identifying engine modes corresponding to the hit web page internal information and/or website property and/or address of the server and/or opening time duration, analyzing to obtain an engine mode with the highest weight with reference to the weights of the hit web page internal information and/or website property and/or address of the server and/or opening time duration, and making said browser to operate in said engine mode.

Further, when said web page internal information at least includes a web page script, said browser detects the web page script started by said web page, and performs a hit in said feature library according to an identifier of a control started by said web page script and obtains a corresponding engine mode.

Further, when said web page internal information at least includes a web page object, said browser detects an identifier of the object that the web page attempts to call, and performs a hit in said feature library according to said object identifier and obtains a corresponding engine mode.

Further, when said web page internal information at least includes a Web standard, said browser detects documents related to said web page, obtains the Web standard supported by said web page related documents according to the source codes of said documents, performs a hit in said feature library according to said Web standard and obtains a corresponding engine mode.

Further, when said web page internal information at least includes a page structure of the web page, said browser detects documents related to said web page, obtains said page structure of the web page according to the source codes of said documents, performs a hit in said feature library according to said page structure of the web page and obtains a corresponding engine mode.

Further, when said web page internal information at least includes the number of web page elements, said feature library includes a number threshold, said browser detects the number of web page elements and determines, with reference to the feature library, a relationship between the number of web page elements and the number threshold, and obtains a corresponding engine mode according to said relationship.

Further, when said web page internal information at least includes sizes of web page elements, said feature library includes a size threshold, said browser detects said sizes of web page elements and determines, with reference to the feature library, a relationship between said sizes of web page elements and the size threshold, and obtains a corresponding engine mode according to said relationship.

Further, when said website property at least includes a protocol used by the web page, said browser detects the website of said web page, and obtains the protocol used by the web page according to said website, performs a hit in the feature library, and obtains a corresponding engine mode.

Further, when said website property at least includes a web page port, said browser detects said web page port number, performs a hit at a standard port number in the feature library, and obtains a corresponding engine mode.

Further, when said website property at least includes a suffix of a web page document, said browser detects a filename of said web page document and obtains the suffix, performs a hit in the feature library, and obtains a corresponding engine mode.

Further, said web page internal information is obtained through analysis after obtaining said web page by said browser.

Further, said switching includes switching automatically by said browser and/or prompting the user to switch.

To solve the above-mentioned technical problem, the present invention also discloses a browser having an engine mode switching function, which comprising: a browser body, a switching module, a feature library, wherein said browser body is adapted to opening a web page in the current engine mode; said switching module is adapted to collecting at least one type of web page internal information of said web page and switching to a matching engine mode with reference to said feature library and informing the browser body to load; said feature library is adapted to storing a corresponding relation between each type of web page internal information and the matching engine mode, said web page internal information being obtained by analysis after said browser having obtained said web page.

Further, said feature library also storing a corresponding relation between each type of website property and the matching engine mode; said switching module is also adapted to collecting at least one type of website property of said web page and switching to the matching engine mode with reference to said feature library and informing said browser body to load.

Further, said feature library further comprising a corresponding relation between the address format and the matching engine mode; said switching module is further adapted to collecting addresses of servers where web pages are located, and switching to the matching engine mode with reference to said feature library and informing said browser body to load.

Further, said feature library further comprising a time duration threshold; said switching module is further adapted to detecting the time duration for opening the web page, if said time duration exceed said time duration threshold, switching to the matching engine mode and informing said browser body to load.

Further, said switching module is further adapted to setting priorities for the engine modes, collecting various web page internal information and/or website property and/or address of the server and/or opening time duration of the web page, and performing a hit in said feature library, identifying an engine mode with the highest priority among the engine modes respectively corresponding to the hit web page internal information and/or website property and/or address of the server and/or opening time duration, and informing the browser body to load said engine mode.

Further, said switching module is further adapted to setting priorities for said various web page internal information and/or website property and/or address of the server and/or opening time duration, collecting one by one the web page internal information or website property and/or address of the server and/or opening time duration of said web page according to the order of priorities, and performing a hit in said feature library, if hit and an engine mode different from the current engine mode is matched, stopping the collection and switching to said engine mode, and informing said browser body to load.

Further, said switching module is further adapted to setting weights for said various web page internal information and/or website property and/or address of the server and/or opening time duration, collecting various web page internal information and/or website property and/or address of the server and/or opening time duration of said web page, and performing a hit in said feature library, identifying engine modes corresponding to the hit web page internal information and/or website property and/or address of the server and/or opening time duration, and analyzing to obtain an engine mode with the highest weight with reference to the weights of the hit web page internal information and/or website property and/or address of the server and/or opening time duration, and informing said browser body to load said engine mode.

Further, when said web page internal information at least includes a web page script, said switching module detects the web page script started by said web page, and performs a hit in said feature library according to an identifier of a control started by said web page script and obtains a corresponding engine mode.

Further, when said web page internal information at least includes a web page object, said switching module detects an identifier of the object that the web page attempts to call, and performs a hit in said feature library according to said object identifier and obtains a corresponding engine mode.

Further, when said web page internal information at least includes a Web standard, said switching module detects documents related to said web page, obtains the Web standard supported by said web page related documents according to the source codes of said documents, performs a hit in said feature library according to said Web standard and obtains a corresponding engine mode.

Further, when said web page internal information at least includes a page structure of the web page, said switching module detects documents related to said web page, obtains said page structure of the web page according to the source codes of said documents, performs a hit in said feature library according to said page structure of the web page and obtains a corresponding engine mode.

Further, when said web page internal information at least includes a number of web page elements, said feature library includes a number threshold, said switching module detects said number of web page elements and determines, with reference to the feature library, a relationship between said number of web page elements and the number threshold, and obtains a corresponding engine mode according to said relationship.

Further, when said web page internal information at least includes sizes of web page elements, said feature library includes a size threshold, said switching module detects said sizes of web page elements and determines, with reference to the feature library, a relationship between said sizes of web page elements and the size threshold, and obtains a corresponding engine mode according to said relationship.

Further, when said website property at least includes a protocol used by the web page, said switching module detects the website of said web page, and obtains the protocol used by the web page according to said website, performs a hit in the feature library, and obtains a corresponding engine mode.

Further, when said website property at least includes a web page port, said switching module detects said web page port number, performs a hit at a standard port number in the feature library, and obtains a corresponding engine mode.

Further, when said website property at least includes a suffix of a web page document, said switching module detects a filename of said web page document and obtains the suffix, performs a hit in the feature library, and obtains a corresponding engine mode.

Further, said web page internal information is obtained through analysis after obtaining said web page by said switching module.

Compared to the prior arts, the present invention achieves the following technical effects:

1) ensuring correctness of engine mode switching, and helping the user to intelligently solve problems especially when problems occur when opening a web page for browsing, and even before the user discovers the problems, thereby guaranteeing to the maximum extend that the user can correctly open web pages using the browser;

2) performing a fast identification before opening the web page without influencing using by the user, and while ensuring the correctness of the engine mode switched, users will not sense the existence of the mode switching;

3) the browser performing the switching according to the address of the server where the web page is located and the web page opening speed, thus further ensuring the correctness of switching.

### BRIEF DESCRIPTION OF THE DRAWINGS

FIG. 1 is a flow chart of a first embodiment of the present invention;

FIG. 2 is a flow chart of a second embodiment of the present invention;

FIG. 3 is a flow chart of a third embodiment of the present invention;

FIG. 4 is a flow chart of a fourth embodiment of the present invention;

FIG. 5 is a flow chart of a fifth embodiment of the present invention;

FIG. 6 is a flow chart of a sixth embodiment of the present invention;

FIG. 7 is a diagram of application of the present invention.

### DETAILED DESCRIPTION OF THE INVENTION

The ways of implementation of the present invention are described in detail below with reference to the drawings and in conjunction with the embodiments, by means of which a full understanding of how the present invention uses technical means to solve technical problems and achieve technical effects can be enabled and thus an implementation can be made.

The core idea of the present invention lies in: building the feature library which stores the corresponding relation between each type of web page internal information and the matching engine mode, said web page internal information being obtained through analysis after said browser obtains said web page; when the browser has opened a web page in the current engine mode, collecting at least one type of web page internal information of said web page and switching to the matching engine mode with reference to the feature library, thus ensuring correctness of engine mode switching, and helping the user to intelligently solve problems especially when problems occur when opening a web page for browsing, and even before the user discovers the problems, and guaranteeing to the maximum extend that the user can correctly open web pages using the browser. The technical defects mentioned in the background of the invention can be overcome in this way.

In addition, said feature library also stores the corresponding relation between each type of website property and the matching engine mode, in the process of a browser attempting to open a web page in the current engine mode, the browser also collects at least one website property of said web page and switches to the matching engine mode with reference to the feature library. Thus the fast identification is performed before opening the web page without influencing using by the user, and while ensuring the correctness of the engine mode switched, users will not sense the existence of the switching mode;

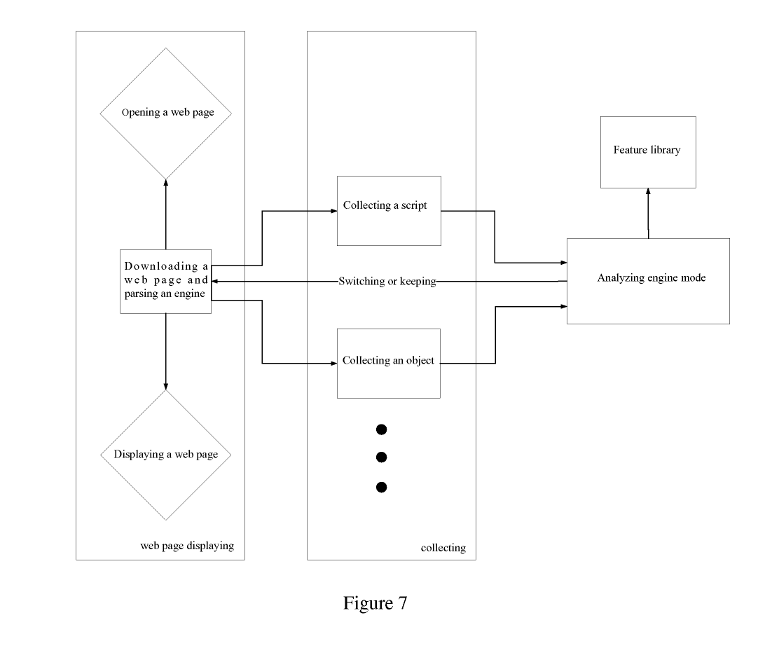

FIG. 7 is a diagram of application of the present invention, in which the collecting operation, analyzing operation and feature library part are scopes involved in the solution of the present invention. The browser having an engine mode switching function according to the present invention comprises: a browser body, a switching module, and a feature library, wherein said browser body performs the web page displaying operation as shown in FIG. 7 and is adapted to opening a web page in the current engine mode, i.e. loading a parsing engine and downloading web pages triggered by the user, and then opening the web pages for displaying; said switching module is connected to the browser body and the feature library respectively to perform the collecting operation and analyzing operation in FIG. 7, when the browser body has opened a web page in the current engine mode, said switching module is adapted to collecting at least one type of web page internal information of said web page, and switching to the matching engine mode with reference to said feature library and informing the browser body to load; said feature library stores the corresponding relation between each type of web page internal information and the matching engine mode, said web page internal information being obtained by analysis after said browser having obtained said web page.

In addition, said feature library also stores a corresponding relation between each type of website property and the matching engine mode; and in the process of the browser body attempting to open a web page in the current engine mode, said switching module further collects at least one type of website property of said web page and switches to the matching engine mode with reference to the feature library and informs the browser body to load.

Said feature library further includes a corresponding relation between the address format and the matching engine mode; and when the browser body has opened a web page or is opening a web page in the current engine mode, said switching module further collects addresses of the servers where the web pages are located, and switches to the matching engine mode with reference to the feature library and informs the browser body to load.

Said feature library further comprises a time duration threshold; when the browser body opens a web page in the current engine mode, said switching module detects the time duration for opening the web page, and switches to the matching engine mode and informs the browser body to load if said time duration exceeds the time duration threshold, otherwise, it remains in the current engine mode.

The structures and functions of the browser described above correspond to the method flows in the embodiments that will be described below, so they will not be elaborated one by one any more, and for details thereof, reference can be made to descriptions of the flow operations in the following embodiments.

The present invention performs the switching on the basis of web pages. When a plurality of web pages have been opened, if identifying that one of said web pages requires a switching of the engine mode, then a switching is performed only for this web page, while the original engine mode is kept for the rest of the web pages.

The first part described below, including the first, second and third embodiments, introduces how the browser (mainly the switching module in combination with the feature library in the browser) switches the engine modes through the website property in the process of opening the web pages in the present invention.

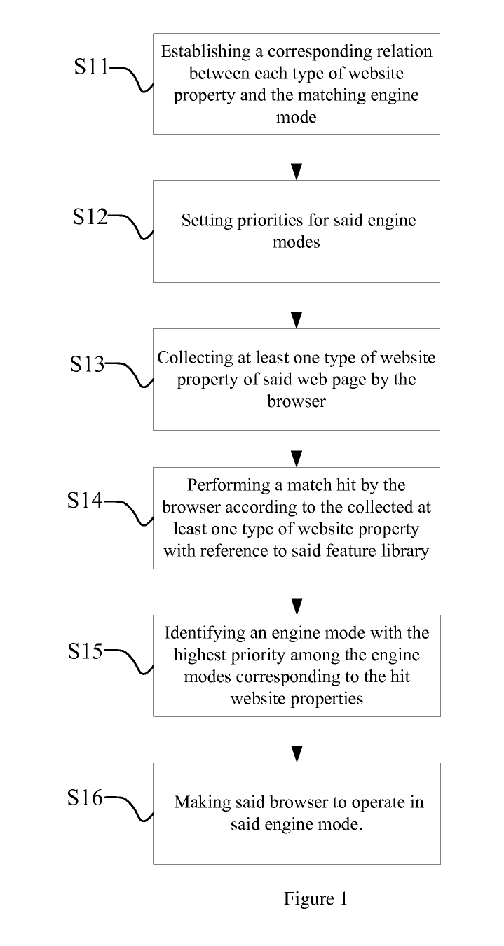

The present invention is described below using the first embodiment. The browser is set to be a WebKit/IE dual-engine browser, but the present invention is not limited to this, and it is also applicable to multiple-engine browsers. As shown in FIG. 1, the following operations are performed:

Step S11: building a feature library which stores the corresponding relation between each type of website property and the matching engine mode.

The website property at least includes: a protocol used by a web page, a web page port and a suffix of a web page document.

Step S12: setting priorities for said engine modes.

The priorities are usually ordered according to the compatibility, and the engine mode with the best compatibility is set to have the highest priority, for example, during actual operation, the IE core is used as the engine with the highest priority, but the present invention is not limited to this.

Step S13: when a user uses a browser to attempt to open a web page in a default engine mode and the web page is not opened yet, collecting at least one type of website property of said web page by the browser.

Usually, the default engine mode is set to be the engine mode with poor compatibility but best performance, for example, during actual operations, the WebKit core is used as the default engine, but the present invention is not limited to this.

Step S14: performing a match hit by the browser according to the collected at least one type of website property with reference to said feature library.

The browser collects a protocol used by the web page, detects the protocol used by the web page and hits the protocol in the feature library, and obtains an engine mode corresponding to said protocol according to the hit protocol. For example, through a website FTP// . . . of a web page, it can be learned that said web page uses a FTP protocol (File Transmission protocol), then a hit is performed in the feature library according to the FTP protocol to hit the FTP protocol and learn that an IE core is corresponding to said web page, so the page of the FTP protocol displayed by a browser based on the IE core is more friendly.

The browser collects the port used by the web page, and detects the web page port number and hits the standard port number in the feature library, and obtains a corresponding engine mode according to the result of hit. For example, web page ports usually use a default 80 port, so the standard port number set in the feature library is 80, if the web page port is not 80, then the IE core is preferred; it is detected whether the web page port number is hit in the feature library, if not, it means that the web page port at the time is not 80, and it is learned that said web page corresponds to the IE core.

When the browser collets the suffix of a web page document, it detects said suffix of the web page document and makes a hit in the feature library, and obtains the corresponding engine mode according to the hit suffix. This web page document may be downloaded locally or opened on the basis of the web page. For example, a suffix MHT is set in the feature library, and documents with this suffix are supported only by the IE core, and it is detected whether the suffix MHT of the filename mail.mht of a web page related document is hit in the feature library, if yes, it means that the web page document can only be displayed by the IE core at this time, so it is learned that this web page corresponds to the IE core.

Step S15: identifying an engine mode with the highest priority among the engine modes corresponding to the hit website properties.

It is discovered, according to the engine modes corresponding to the website properties hit in step S14, that said web page has three website properties that correspond to the IE core, and the IE core has a high priority because of its good compatibility, so the browser identifies the IE core with the highest priority.

Step S16: making said browser to operate in said engine mode.

Said browser automatically switches from the default WebKit core to the IE core or prompts the user to manually switch from the default WebKit core to the IE core so as to display the current web page. Of course, the browser may remain operating under the WebKit core depending on the result of collection and analysis in steps S13-S15.

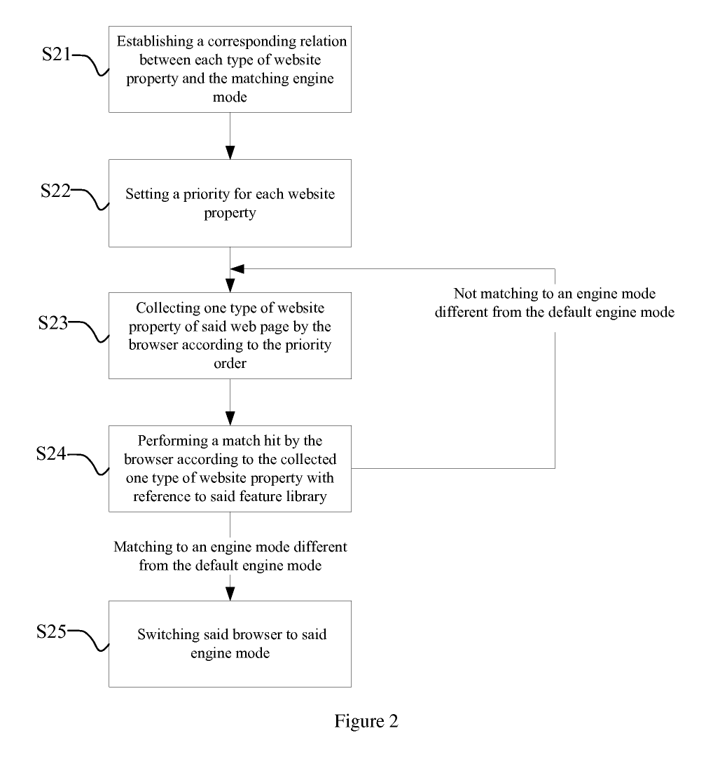

The present invention is described below using the second embodiment. The browser is set to be a WebKit/IE dual-engine mode browser, but the present invention is not limited to this, and it is also applicable to multiple-engine browsers. As shown in FIG. 2, the following operations are performed:

Step S21: building a feature library which stores a corresponding relation between each type of website property and the matching engine mode.

The website property at least includes: a protocol used by a web page, a web page port and a suffix of a web page document.

Step S22: setting a priority for each website property. For example, the degree of importance of the website property is identified according to experience so as to set its priority.

Step S23: when a user uses a browser to attempt to open a web page in a default engine mode and the web page is not opened yet, collecting one type of website property of said web page by the browser according to the priority order.

Usually, the default engine mode is set to be the engine mode with poor compatibility but best performance, for example, during actual operations, the WebKit core is used as the default engine, but the present invention is not limited to this.

Step S24: performing a match hit by the browser according to the collected one type of website property with reference to said feature library.

If an engine mode different from the default engine mode is not matched, it will not be considered to switch the engine mode according to said website property, and returning to step S23; if an engine mode different from the default engine mode is matched, proceeding to step S25.

Referring to step S14, the current default engine mode is based on the WebKit core, then the protocol used by the web page, the web page port and the suffix of the web page document are collected and matched one by one according to the priority order, once an engine mode different from the default engine mode is matched, this engine mode is the IE core in this example, and proceeding to step S25; otherwise, the default engine mode is kept and returning to step S23.

Step S25: switching said browser to said engine mode.

Said browser automatically switches from the default WebKit core to the IE core or prompts the user to manually switch from the default WebKit core to the IE core so as to display the current web page.

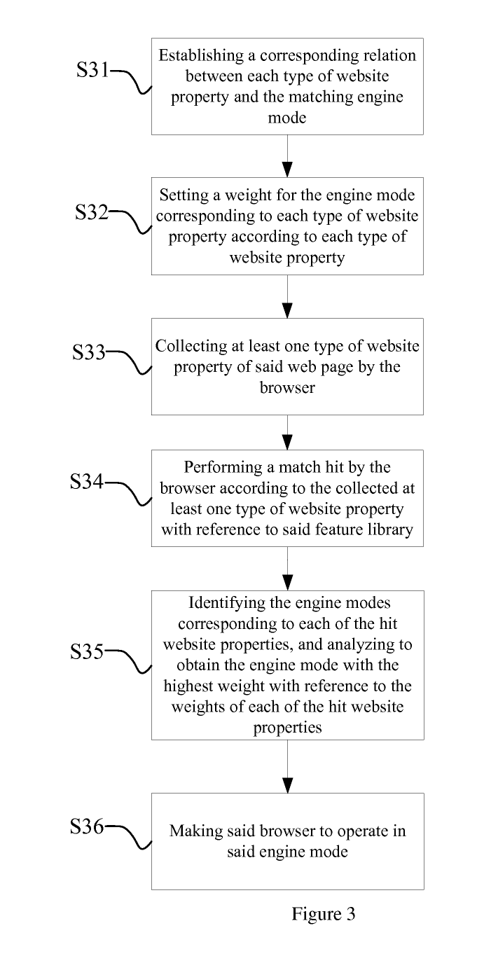

The present invention is described below using the third embodiment. The browser is set to be a WebKit/IE dual-engine mode browser, but the present invention is not limited to this, and it is also applicable to multiple-engine browsers. As shown in FIG. 3, the following operations are performed:

Step S31: building a feature library which stores a corresponding relation between each type of website property and the matching engine mode.

The website property at least includes: a protocol used by a web page, a web page port and a suffix of a web page document.

Step S32: setting a weight for the engine mode corresponding to each type of website property according to each type of website property.

For example, the degree of importance of the website property is identified according to experience, the weight of the engine mode corresponding to the protocol used by the web page can be set to be 3, the weight of the engine mode corresponding to the web page port can be set to be 1, and the weight of the engine mode corresponding to the suffix of the web page document can be set to be 2, of course, the present invention is not limited to this.

Step S33: when a user uses a browser to attempt to open a web page in a default engine mode and the web page is not opened yet, collecting at least one type of website property of said web page by the browser.

Usually, the default engine mode is set to be the engine mode with poor compatibility but best performance, for example, during actual operations, the WebKit core is used as the default engine, but the present invention is not limited to this.

Step S34: performing a match hit by the browser according to the collected at least one type of website property with reference to said feature library.

As for the specific operations of the match hit, reference can be made to step S14.

Step S35: identifying the engine modes corresponding to each of the hit website properties, and analyzing to obtain the engine mode with the highest weight with reference to the weights of each of the hit website properties.

It is discovered by identifying the engine modes corresponding to each of the hit website properties that said web page has three website properties that correspond to the IE core, which are the protocol used by the web page, the web page port and the suffix of the web page document; and with reference to the weights, it is obtained through analysis that the IE core has the highest weight.

Step S36: making said browser to operate in said engine mode.

Said browser automatically switches from the default WebKit core to the IE core or prompts the user to manually switch from the default WebKit core to the IE core so as to display the current web page. Of course, the browser may remain operating under the WebKit core depending on the result of collection and analysis in steps S33-S35.

The second part described below, including the fourth, fifth and sixth embodiments, introduces how the browser (mainly the switching module in combination with the feature library in the browser) switches the engine modes through the web page internal information when the web page has been opened in the present invention. Said web page internal information is obtained through analysis after said browser obtaining said web page.

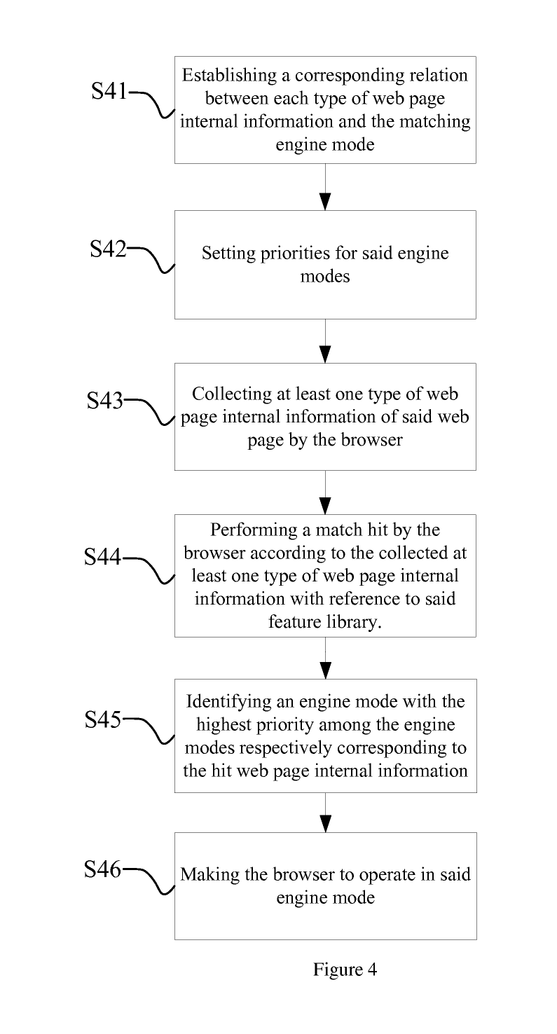

The present invention is described below using the fourth embodiment. The browser is set to be a WebKit/IE dual-engine mode browser, but the present invention is not limited to this, and it is also applicable to multiple-engine browsers. As shown in FIG. 4, the following operations are performed:

Step S41: building a feature library which stores a corresponding relation between each type of web page internal information and the matching engine mode.

The web page internal information at least include the web page script, web page object, Web standard, page structure of web page, number of web page elements and sizes of web page elements.

Step S42: setting priorities for said engine modes.

The priorities are usually ordered according to the compatibility, and the engine mode with the best compatibility is set to have the highest priority, for example, during actual operation, the IE core is used as the engine with the highest priority, but the present invention is not limited to this.

Step S43: when a user uses a browser to open a web page in a default engine mode and the web page is opened, collecting at least one type of web page internal information of said web page by the browser.

Usually, the default engine mode is set to be the engine mode with poor compatibility but best performance, for example, during actual operations, the WebKit core is used as the default engine, but the present invention is not limited to this.

Step S44: performing a match hit by the browser according to the collected at least one type of web page internal information with reference to said feature library.

The browser collects a script file which currently is opened by the web page and attempts to start a control, detects an identifier of said control and performs a hit in the feature library, and obtains a corresponding engine mode for running said control. For example, File Download is clicked in the current web page and a JS (javascript, a client script driven on the basis of objects and events and having relative security) is activated, and this script file attempts to start a download tool which is more suitable to run in a browser of an IE core, thus a hit is performed in said feature library according to the identifier of said download tool to learn that said download tool corresponds to an IE core.

The browser collects a web page object that is to be called by the web page currently, detects an identifier of said object and hits in the feature library, and obtains a corresponding engine mode for running said object. For example, a Video Play is clicked in the present web page, then the control for playing the video will be called from the ClassID of the registry of the system where the browser is located, since this control can only run in a browser of an IE core, a hit is performed in the feature library according to the identifier of said control to learn that calling of this control should be based on the IE core.

The browser collects the Web standard, detects the document related to the web page, obtains the Web standard supported by said web page according to the web page Head description in the source code of said document, performs a hit in said feature library according to said Web standard, and obtains a corresponding engine mode. For example, a source document index.htm of the present web page is obtained, and it is learned from the Head description of the source code of said document that said web page supports CSS 3.0 (Cascading Style Sheet), and a hit is performed in said feature library according to the identifier of said version to learn that said web page needs to be opened on the basis of a WebKit core.

The browser detects the document related to the web page, collects the page structure of the web page therefrom according to the source code of said document, performs a hit in said feature library according to said page structure of the web page and obtains a corresponding engine mode. For example, a document of said web page is detected, which is written using Dreamweaver 8.0, a specified border width of one table in said web page is obtained according to the source code, and performs a hit in the feature library according to this specified border width to obtain that the engine mode corresponding to said border width is WebKit and that such page structure is more suitable to be displayed in a WebKit core.

The browser detects the number of elements of the web page in a default core, said feature library including a number threshold, obtains a relationship between the number of web page elements and the number threshold in said feature library, and obtains a corresponding engine mode according to said relationship. For example, said feature library includes a number threshold A, if the number of elements of the current web page is greater than A, it means that the number of elements of the current web page is large, so a corresponding core is obtained. In this embodiment, a large number of elements should correspond to a WebKit core.

The browser detects the sizes of elements of the web page in a default core, said feature library including a size threshold, obtains a relationship between the sizes of web page elements and the size threshold in said feature library, and obtains a corresponding engine mode according to said relationship. For example, said feature library includes a size threshold B, if the sizes of the current web page elements are greater than B, it means that the current web page elements have large sizes, and a corresponding core is obtained. In this embodiment, large sizes of web page elements should correspond to a WebKit core; said sizes of web page elements include: dimension of solution and/or size of document.

Step S45: identifying an engine mode with the highest priority among the engine modes respectively corresponding to the hit web page internal information.

It is discovered from the engine modes corresponding to the web page internal information hit in step S44 that said web page has two pieces of web page internal information that correspond to the IE core, and four pieces of web page internal information that correspond to the WebKit core, but the IE core has a higher priority because of its good compatibility, so the browser identifies the IE core with the highest priority.

Step S46: making the browser to operate in said engine mode. Said browser automatically switches from the default WebKit core to the IE core or prompts the user to manually switch from the default WebKit core to the IE core so as to display the current web page. Of course, the browser may remain operating under the WebKit core depending on the result of collection and analysis in steps S43-S45.

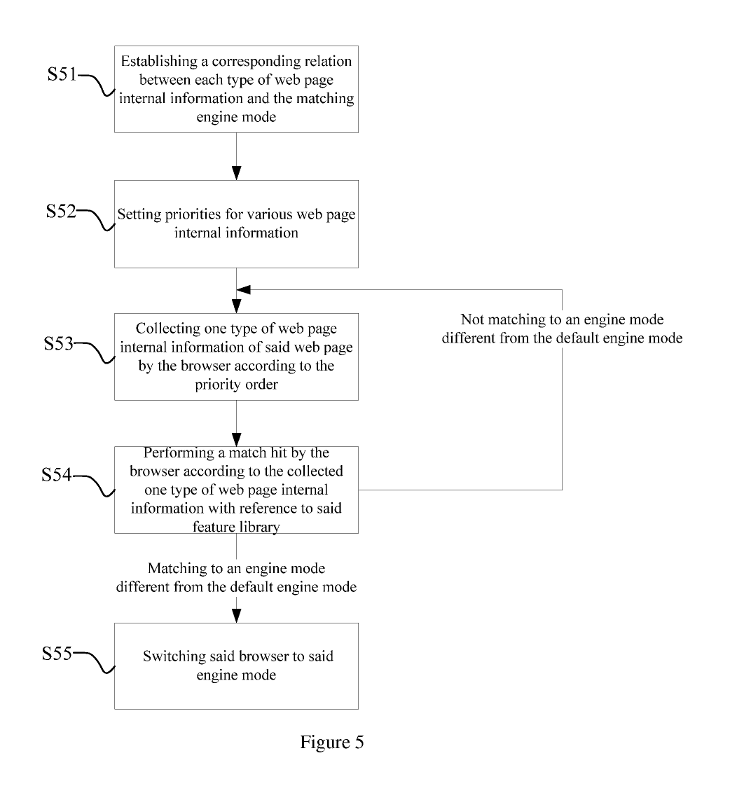

The present invention is described below using the fifth embodiment. The browser is set to be a WebKit/IE dual-engine mode browser, but the present invention is not limited to this, and it is also applicable to multiple-engine browsers. As shown in FIG. 5, the following operations are performed:

Step S51: building a feature library which stores a corresponding relation between each type of web page internal information and the matching engine mode.

The web page internal information at least include the web page script, web page object, Web standard, page structure of web page, number of web page elements and sizes of web page elements.

Step S52: setting priorities for various web page internal information.

For example, the degree of importance of the web page internal information is identified according to experience so as to set its priority.

Step S53: when a user uses a browser to open a web page in a default engine mode and the web page is opened, collecting one type of web page internal information of said web page by the browser according to the priority order.

Usually, the default engine mode is set to be the engine mode with poor compatibility but best performance, for example, in actual operations, the WebKit core is used as the default engine, but the present invention is not limited to this.

Step S54: performing a match hit by the browser according to the collected one type of web page internal information with reference to said feature library.

If an engine mode different from the default engine mode is not matched, it will not be considered to switch the engine mode according to said web page internal information, and return to step S53; if an engine mode different from the default engine mode is matched, proceed to step S55.

Referring to step S44, the current default engine mode is based on the WebKit core, then the web page script, web page object, Web standard, page structure of web page, number of web page elements and sizes of web page elements are collected and matched one by one according to the priority order, once an engine mode different from the default engine mode is matched, this engine mode is the IE core in this example, and step S55 is performed; otherwise, the default engine mode is kept and step S53 is performed.

Step S55: switching said browser to said engine mode.

Said browser automatically switches from the default WebKit core to the IE core or prompts the user to manually switch from the default WebKit core to the IE core so as to display the current web page.

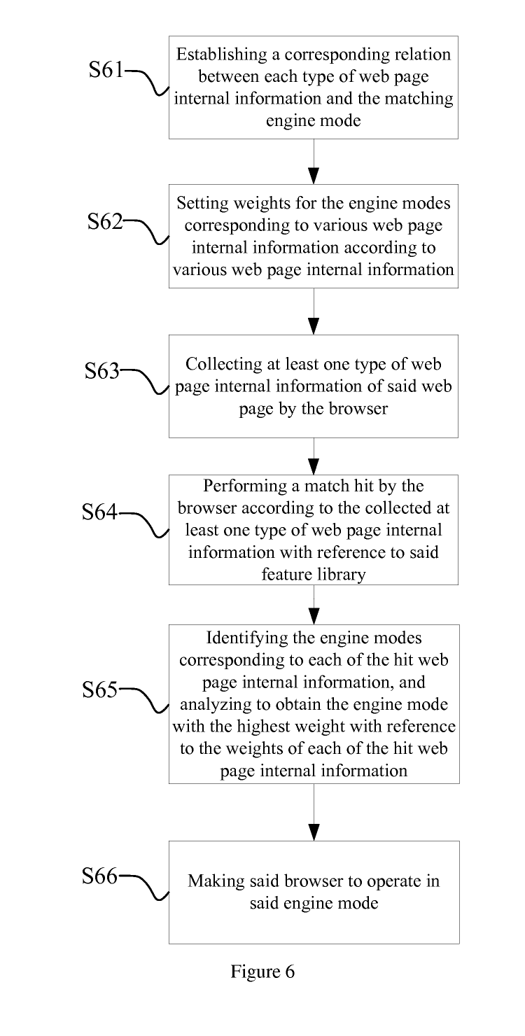

The present invention is described below using the sixth embodiment. The browser is set to be a WebKit/IE dual-engine mode browser, but the present invention is not limited to this, and it is also applicable to multiple-engine browsers. As shown in FIG. 6, the following operations are performed:

Step S61: building a feature library which stores a corresponding relation between each type of web page internal information and the matching engine mode.

The web page internal information at least include the web page script, web page object, Web standard, page structure of web page, number of web page elements and sizes of web page elements.

Step S62: setting weights for the engine modes corresponding to various web page internal information according to various web page internal information.

For example, the degree of importance of the web page internal information is identified according to experience, the weight of the engine mode corresponding to the web page script can be set to be 3, the weight of the engine mode corresponding to the web page object can be set to be 3, the weight of the engine mode corresponding to the Web standard can be set to be 3, the weight of the engine mode corresponding to the page structure of the web page can be set to be 2, the weight of the engine mode corresponding to the number of web page elements can be set to be 1, and the weight of the engine mode corresponding to the sizes of web page elements can be set to be 1, of course, the present invention is not limited to this.

Step S63: when a user uses a browser to open a web page in a default engine mode and the web page is opened, collecting at least one type of web page internal information of said web page by the browser.

Usually, the default engine mode is set to be the engine mode with poor compatibility but best performance, for example, in actual operations, the WebKit core is used as the default engine, but the present invention is not limited to this.

Step S64: performing a match hit by the browser according to the collected at least one type of web page internal information in combination with said feature library.

As for the specific operations of the match hit, reference can be made to step S44.

Step S65: identifying the engine modes corresponding to each of the hit web page internal information, and analyzing to obtain the engine mode with the highest weight with reference to the weights of each of the hit web page internal information.

It is discovered by identifying the engine modes corresponding to the hit web page internal information that said web page has two pieces of web page internal information that correspond to the IE core, which are the web page script and the web page object, and has four website properties that correspond to the WebKit core, which are the Web standard, the page structure of the web page, the number of web page elements and the sizes of web page elements; and with reference to the weights, it is obtained through analysis that the WebKit core has the highest weight.

Step S66: making said browser to operate in said engine mode.

Said browser remains at the default WebKit core to display the current web page. Of course, the browser may switch from the WebKit core to the IE core depending on the result of collection and analysis in steps S63-S65.

It shall be noted that the solutions in the above first part and second part can be used in combination, for example, the first embodiment can be combined with the fourth embodiment, i.e. performing steps S11-S16 in the stage of opening the web page, and performing steps S41-S46 during browsing the web page after opening the web page, and finally determining the matching engine mode and performing the switching; or the second embodiment can be combined with the fifth embodiment, i.e. performing steps S21-S26 in the stage of opening the web page, and performing steps S51-S56 during browsing the web page after opening the web page, and finally determining the matching engine mode and performing the switching; or the third embodiment can be combined with the sixth embodiment, i.e. performing steps S31-S36 in the stage of opening the web page, and performing steps S61-S66 during browsing the web page after opening the web page, and finally determining the matching engine mode and performing the switching.

Of course, the first embodiment can be combined with the fifth or sixth embodiment, i.e. switching in the light of the engine mode priority according to the website property in the stage of opening the web page, and after opening the web page, switching the engine mode in the light of the priority or weight of the web page internal information according to the web page internal information during browsing the web page; or the second embodiment can be combined with the fourth or sixth embodiment, i.e. switching in the light of the website property priority according to the website property in the stage of opening the web page, and after opening the web page, switching the engine mode in the light of the priority or weight of the engine mode according to the web page internal information during browsing the web page; or the third embodiment can be combined with the fourth or fifth embodiment, i.e. switching in the light of the weight according to the website property in the stage of opening the web page, and after opening the web page, switching the engine mode in the light of the priority or weight of the engine mode according to the web page internal information during browsing the web page.

Now, in the solution of the third part below, it will be described how the browser (mainly the switching module in combination with the feature library in the browser) switches the engine mode through the address format during opening of the web page or after opening the web page. It can be performed in the same process as the solution of the first part and be performed in cooperation with the solution of the second part, or it may be performed at the same time as the solution of the second part and be performed in cooperation with the solution of the first part, or it can be performed in the same process as the solution of the first part or be performed at the same time as the solution of the second part.

Said feature library also stores a corresponding relation between the server address format and the matching engine mode; the browser also collects the address of the server where the web page is located and switches to the matching engine mode with reference to the feature library, thus further ensuring the switching correctness. For example, the address format stored in the feature library includes public addresses and private addresses, and generally, web pages of private addresses can be consider as being based on the IE core; in the process of the browser attempting to open a web page in a default engine mode or when a web page has been opened, the IP address of the server where said web page is located is collected to be 192.168.*.*, and a hit is performed in said feature library according to said IP address, if said IP address is hit to be a private address, it is obtained that the corresponding engine mode is the IE core.

Afterwards, a priority or weight or a priority based on said engine mode may be set for the address format in the way described above, which is used in conjunction with said website property and web page internal information for finally determining and switching to the matching engine mode.

Now, in the solution of the fourth part below, it will be described how the browser (mainly the switching module in combination with the feature library in the browser) switches the engine mode through the time duration for opening the web page in the process of opening the web page. It can be performed in the same process as the solution of the first and/or third part and be performed in cooperation with the solution of the second part, or it may be performed at the same time as the solution of the first part and be performed in cooperation with the solutions of the second and third parts.

Said feature library also stores a time duration threshold; when the browser opens a web page in a default engine mode, the time duration for opening said web page in the default core is detected, and a determination is made in conjunction with said feature library, if said time duration exceeds said time duration threshold, a switching to the matching engine mode is performed, otherwise, the current engine mode is maintained. For example, said feature library includes a time duration threshold of 20 seconds, while the time duration for opening the current web page is 30 seconds, the time duration threshold is exceeded before opening the web page, then it means that the current default core is not suitable for this web page and a switching to the matching core is performed; if the web page is opened within 20 seconds, the current engine mode is maintained.

A priority or weight or a priority based on said engine mode may be set for the opening time duration in the way described above, which is used in conjunction with said website property, web page internal information and address format for finally determining and switching to the matching engine mode.

The above texts illustrate several preferred embodiments of the present invention, but as mentioned before, it shall be understood that the present invention is not limited to the form disclosed herein and it does not intend to exclude other embodiments, but it can be applied to various other combinations, modifications and contexts, and it can be altered by means of the above teachings or the techniques or knowledge in the relevant field within the scope of inventive concept described herein. Any changes and modifications made by those skilled in the art that do not depart from the spirit and scope of the present invention shall fall within the protection scope of the appended claims.

### INDUSTRIAL APPLICABILITY

The present invention can effectively detect on which core the current web page is based so as to switch the browser to the corresponding engine mode. First, it ensures correctness of engine mode switching, and helps the user to intelligently solve problems especially when problems occur when opening a web page for browsing, and even before the user discovers the problems, thereby guaranteeing to the maximum extend that the user can correctly open web pages using the browser; besides, it performs a fast identification before opening the web page without influencing using by the user, and ensures the correctness of the engine mode switched, while users will not sense the existence of the mode switching; in addition, the browser performs the switching according to the address of the server where the web page is located and the web page opening speed, thus further ensuring the correctness of switching.

1. A method for switching browser engine mode, comprising:
building a feature library which includes a corresponding relation between each type of web page internal information and the matching engine mode;
when the browser has opened a web page in the current engine mode, collecting at least one type of web page internal information of said web page and switching to the matching engine mode with reference to the feature library.

2. The method for switching according to claim 1, further comprising:
said feature library further including a corresponding relation between each type of website property and the matching engine mode;
when the browser has opened a web page in the current engine mode, collecting at least one type of website property of said web page and switching to the matching engine mode with reference to the feature library.

3. The method for switching according to claim 2, further comprising:
said feature library further includes a corresponding relation between the address format and the matching engine mode;
when the browser has opened a web page or is opening a web page in the current engine mode, collecting addresses of the servers where the web pages are located, and switching to the matching engine mode with reference to the feature library.

4. The method for switching according to claim 3, further comprising:
said feature library further including a time duration threshold;
when the browser opens a web page in the current engine mode, detecting the time duration for opening the web page, if said time duration exceeds the time duration threshold, switching to the matching engine mode, otherwise, remaining at the current engine mode.

5. The method for switching according to claim 4, wherein the step of switching to the matching engine mode with reference to the feature library further including:
setting priorities for said engine modes, collecting various web page internal information and/or website property and/or address of the server and/or opening time duration of the web page, and performing a hit in said feature library, identifying an engine mode with the highest priority among the engine modes respectively corresponding to the hit web page internal information and/or website property and/or address of the server and/or opening time duration, and making the browser to operate in said engine mode.

6. The method for switching according to claim 4, wherein the step of switching to the matching engine mode with reference to the feature library further including:
setting priorities for said various web page internal information and/or website property and/or address of the server and/or opening time duration, collecting one by one the web page internal information or website property and/or address of the server and/or opening time duration of said web page according to the order of priorities, and performing a hit in said feature library, if hit and an engine mode different from the current engine mode is matched, stopping the collection and switching the browser to said engine mode.

7. The method for switching according to claim 4, wherein the step of switching to the matching engine mode with reference to the feature library further including:
setting weights for said various web page internal information and/or website property and/or address of the server and/or opening time duration, collecting various web page internal information and/or website property and/or address of the server and/or opening time duration of said web page, performing a hit in said feature library, identifying engine modes corresponding to the hit web page internal information and/or website property and/or address of the server and/or opening time duration, analyzing to obtain an engine mode with the highest weight with reference to the weights of the hit web page internal information and/or website property and/or address of the server and/or opening time duration, and making said browser to operate in said engine mode.

8. The method for switching according to claim 1, wherein
when said web page internal information at least includes a web page script, said browser detects the web page script started by said web page, and performs a hit in said feature library according to an identifier of a control started by said web page script and obtains a corresponding engine mode.

9. The method for switching according to claim 1, wherein
when said web page internal information at least includes a web page object, said browser detects an identifier of the object that the web page attempts to call, and performs a hit in said feature library according to said object identifier and obtains a corresponding engine mode.

10. The method for switching according to claim 1, wherein
when said web page internal information at least includes a Web standard, said browser detects documents related to said web page, obtains the Web standard supported by said web page related documents according to the source codes of said documents, performs a hit in said feature library according to said Web standard and obtains a corresponding engine mode.

11. The method for switching according to claim 1, wherein
when said web page internal information at least includes a page structure of the web page, said browser detects documents related to said web page, obtains said page structure of the web page according to the source codes of said documents, performs a hit in said feature library according to said page structure of the web page and obtains a corresponding engine mode.

12. The method for switching according to claim 1, wherein
when said web page internal information at least includes the number of web page elements, said feature library includes a number threshold, said browser detects the number of web page elements and determines, with reference to the feature library, a relationship between the number of web page elements and the number threshold, and obtains a corresponding engine mode according to said relationship.

13. The method for switching according to claim 1, wherein
when said web page internal information at least includes sizes of web page elements, said feature library includes a size threshold, said browser detects said sizes of web page elements and determines, with reference to the feature library, a relationship between said sizes of web page elements and the size threshold, and obtains a corresponding engine mode according to said relationship.

14. The method for switching according to claim 2, wherein
when said website property at least includes a protocol used by the web page, said browser detects the website of said web page, and obtains the protocol used by the web page according to said website, performs a hit in the feature library, and obtains a corresponding engine mode.

15. The method for switching according to claim 2, wherein
when said website property at least includes a web page port, said browser detects said web page port number, performs a hit at a standard port number in the feature library, and obtains a corresponding engine mode.

16. The method for switching according to claim 2, wherein
when said website property at least includes a suffix of a web page document, said browser detects a filename of said web page document and obtains the suffix, performs a hit in the feature library, and obtains a corresponding engine mode.

17. A browser having an engine mode switching function, comprising: a browser body, a switching module and a feature library, wherein,
said browser body is adapted to opening a web page in the current engine mode;
said switching module is adapted to collecting at least one type of web page internal information of said web page and switching to a matching engine mode with reference to said feature library and informing the browser body to load;
said feature library is adapted to storing a corresponding relation between each type of web page internal information and the matching engine mode.

18. The browser according to claim 17, wherein
said feature library also storing a corresponding relation between each type of website property and the matching engine mode;
said switching module is also adapted to collecting at least one type of website property of said web page and switching to the matching engine mode with reference to said feature library and informing said browser body to load.

19. The browser according to claim 18, wherein
said feature library further comprising a corresponding relation between the address format and the matching engine mode;
said switching module is further adapted to collecting addresses of servers where web pages are located, and switching to the matching engine mode with reference to said feature library and informing said browser body to load.

20. The browser according to claim 19, wherein
said feature library further comprising a time duration threshold; said switching module is further adapted to detecting the time duration for opening the web page, if said time duration exceed said time duration threshold, switching to the matching engine mode and informing said browser body to load.
